(19) United States
(12) Patent Application Publication
(10) Pub. No.: US 2006/0148602 A1
(43) Pub. Date: Jul. 6, 2006

(54) Transmission for bicycle

(76) Inventor: Yoshihisa Iwasaki, Nara (JP)

Correspondence Address: BUCKNAM AND ARCHER, 1077 NORTHERN BOULEVARD, ROSLYN, NY, 11576, US

(21) Appl. No.: 10/535,343

(22) PCT Filed: Nov. 26, 2002
(86) PCT No.: PCT/JP02/12333

§ 371 Date: May 18, 2005

(51) Int. Cl. F16H 59/00; F16H 61/00

(52) U.S. Cl. 474/78; 474/80; 474/82

(57) ABSTRACT

A transmission for a bicycle for re-installing a chain in the lateral direction of the bicycle in a front chain wheel having two or more sheets of gear plates, comprising two sheets of guards, i.e., a main guard for re-installing the chain from a middle diameter gear to a large diameter gear and an auxiliary guard for re-installing the chain from a small diameter gear to the middle diameter gear, wherein the main guard is pivotally supported on a link mechanism for moving the guard in the lateral direction of the bicycle and the auxiliary guard is installed on the main guard so as to be elastically displaced.

### TECHNICAL FIELD

The present invention relates to a transmission for a bicycle, and more specifically to a transmission for re-installing the chain in the front chain wheel of a bicycle having two or more sheets of gear plates in the lateral direction.

### BACKGROUND ART

The widely known conventional transmission for a bicycle comprises a front chain wheel with three gears of varying diameters, small, medium and large, with each gear having different number of teeth, juxtaposed in the lateral direction, and a guard for re-installing a chain through a link mechanism. Where the chain is re-installed in the front chain wheel, for example, and a shift lever connected to the transmission of the bicycle is operated through a transmission operating wire, the transmission of the bicycle moves from the side of the small diameter gear to the side of the large diameter gear when the transmission operating wire is pulled, whereby the chain can be re-installed from the small diameter gear to the middle diameter gear and further to the large diameter gear. On the other hand, when the shift lever is operated to loosen the transmission operating wire, the transmission of the bicycle reverts from the side of the large diameter gear to the side of the small diameter gear by the force of a return spring provided on the transmission of the bicycle whereby the chain can be re-installed from the large diameter gear to the middle diameter gear and further to the small diameter gear.

However, where the chain is reinstalled in the front chain wheel having three gears juxtaposed in the lateral direction, it is necessary to extend the internal guard of the transmission of the bicycle toward the shaft axis of the front chain wheel to enhance the shifting performance of the transmission from the small diameter gear to the middle diameter gear. In the process, the chain is caught between the internal guard and the large diameter gear when the middle diameter gear is shifted to the large diameter gear, resulting in lower shifting performance. To solve this problem, various shapes of internal guard have been proposed, none of which have succeeded in attaining satisfactory shifting performance.

Further, where the front wheel chain having two gears juxtaposed in the lateral direction and the transmission of the bicycle for the front chain wheel are combined, the chain sometimes jumps over the small diameter gear and falls off inwardly in the lateral direction of the bicycle when the large diameter gear is shifted to the small diameter gear because there is a large gap between the internal guard and the tooth top of the small diameter gear. Further, during this process, when the conventional transmission of the bicycle extending toward the side of the shaft axis of the front chain wheel is used for the front chain wheel having two gears juxtaposed in the lateral direction, the abovementioned problem similarly occurs, in that the chain is caught between the internal guard and the large diameter gear, resulting in lower shifting performance from the small diameter gear to the large diameter gear.

### DISCLOSURE OF THE INVENTION

Taking into account the abovementioned circumstances, the present invention was conceptualized, with two objectives. The first object of the invention is to enhance the shifting performance of the transmission of the bicycle in the front chain wheel having three or more gears juxtaposed in the lateral direction with two kinds of guards, i.e., a main guard and an auxiliary guard, from the small diameter gear to the middle diameter gear and similarly, from the middle diameter gear to the large diameter gear. The second object of the invention is to prevent the chain from falling off on the side of the small diameter gear when the large diameter gear is shifted to the small diameter gear while simultaneously securing shifting performance from the small diameter gear to the large diameter gear, where the transmission is used together with the front chain wheel comprising two gears.

According to the transmission of the present invention, the guards comprise two kinds, i.e., the main guard and the auxiliary guard, wherein the auxiliary guard is installed on the main guard so as to be displaced radially in the downward direction and elastically with respect to the shaft axis of the front chain wheel, such that when the small diameter gear is shifted to the middle diameter gear, the auxiliary guard can press and shift the chain in the front chain wheel having the three gears juxtaposed in the lateral direction. Further, when the middle diameter gear is shifted to the large diameter gear, the auxiliary guard presses the chain toward the side of the large diameter gear as in the case of the conventional transmission, but since the auxiliary guard is installed on the main guard so as to be elastically displaceable, in the case of a predetermined or more pressing force, it is displaced so as to escape on the side opposite the large diameter gear. As a result, the chain can be shifted to the large diameter gear smoothly without being caught between the guard and the large diameter gear.

Further, where the transmission of the present invention is used for the front wheel chain having two gears juxtaposed in the lateral direction, the shifting property similar to that of the conventional transmission for the front chain wheel having two gears juxtaposed in the lateral direction is obtained when the small diameter gear shifts to the large diameter gear, since the auxiliary guard is displaced, and while the large diameter gear shifts to the small diameter gear, the gap between the internal guard and the tooth top of the small diameter gear becomes smaller, thus preventing the chain from jumping to the small diameter gear and falling off inwardly in the lateral direction of the bicycle.

### BRIEF DESCRIPTION OF THE DRAWINGS

FIG. 1 is the front view of a transmission for a bicycle according to the embodiment of the present invention;

FIG. 2 is the side view of the transmission according to the embodiment of the present invention; while

FIG. 3 is an explanatory view of the present invention in operation when combined with a front chain wheel provided with three gear plates.

FIG. 4 is an explanatory view of the conventional transmission in operation when combined with a front chain wheel provided with three gear plates;

FIG. 5 is another explanatory view of the conventional transmission in operation when combined with a front chain wheel provided with three gear plates.

FIG. 6 is a view showing the second embodiment of the present invention; while

FIG. 7 is a view showing the third embodiment of the present invention.

### BEST MODE FOR CARRYING OUT THE INVENTION

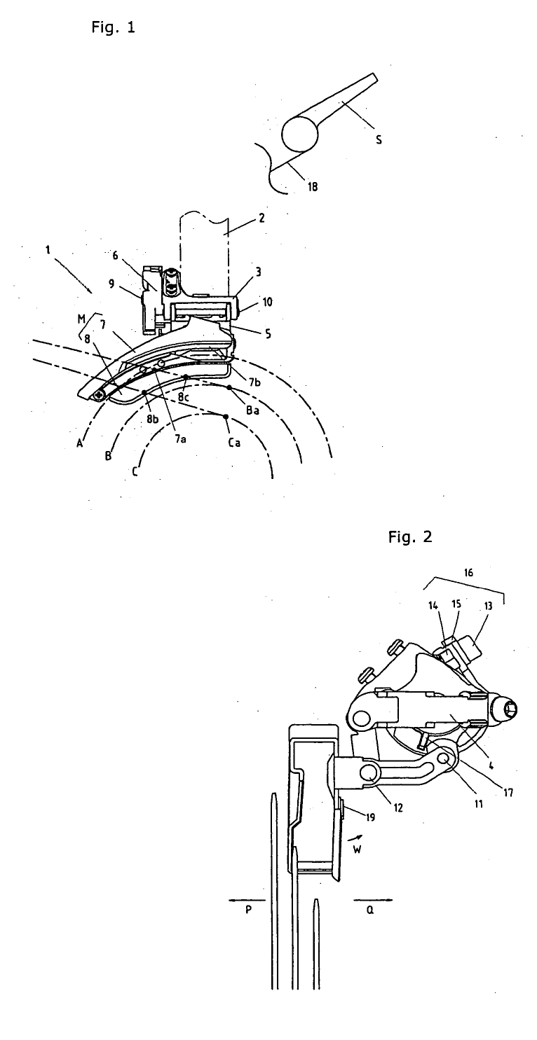

The embodiments of the present invention will be described hereinafter with reference to the drawings. As shown in FIGS. 1 and 2, the transmission for a bicycle 1 of the present invention comprises a frame 3 and a band 4 secured to a seat pipe 2, a link 6 and a link 5 pivotally mounted rotatably on the frame through a shaft 9 and a pin 10, a main guard 7 pivotally mounted on the link 5 and the link 6 rotatably through a pin 12 and a pin 11, and an auxiliary guard 8 secured to the main guard by a pin 19, wherein a guard M is formed to move in the parallel direction.

A return spring 17 is received within the interior of the link 6, and the guard M is biased by the return spring 17 inwardly in the lateral direction of the bicycle (in the direction of arrow Q). In the link 6, a wire connecting portion 16 for connecting a wire 18 extended from a shift lever S is constituted by a bolt 13, a nut 14, and a washer 15, wherein the movement of the guard M externally in the lateral direction of the bicycle (in the direction of arrow P) is effected by drawing the shift lever S, and when the shift lever is returned, the guard M is moved in the direction of arrow Q by the returning force of the return spring. It should be noted that the auxiliary guard is made of material that can be elastically deformed and secured to the main guard by a pin 19 at the rear in the longitudinal direction of the bicycle from the center of the seat pipe.

In the above described bicycle 1 where the transmission is combined with the front chain wheel provided with three gears, normally, the guard M is positioned above a small diameter gear C as shown in FIG. 2 by the return spring 17. When the shift lever S is pulled from this state, the guard M moves upward in the direction of arrow P and is displaced on the middle diameter gear, and the chain is re-installed by being pressed closest to a contact Ca of the small diameter gear C by a lower end portion 8b of the auxiliary guard.

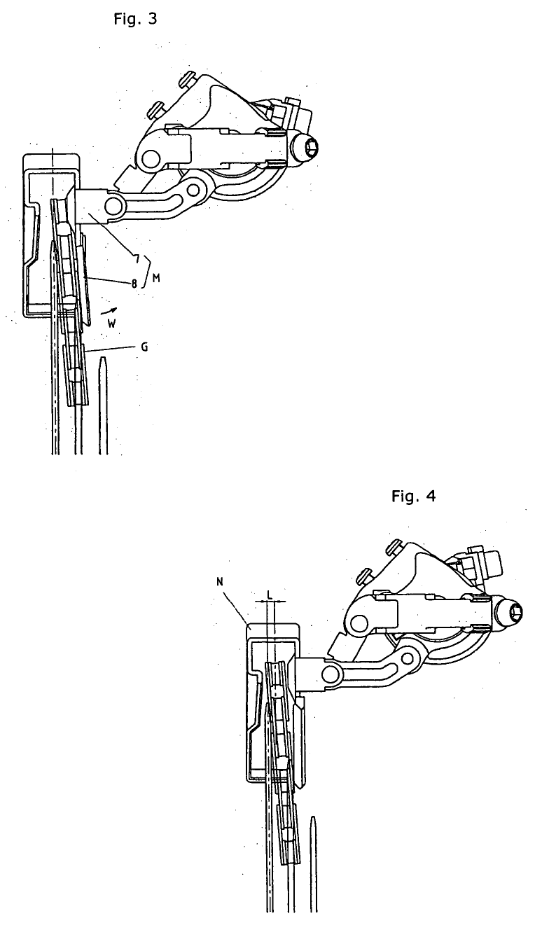

When the shift lever S is further pulled, the guard M moves upward in the direction of arrow P and is displaced on the large diameter gear. On this occasion, the chain is pressed by the lower end portion 8c of the auxiliary guard closest to a contact Ba of the middle diameter gear B so as to be caught on the side of the middle diameter gear of the large diameter gear, but since the auxiliary guard is formed of a material that can be elastically deformed, it escapes onto the side of the small diameter gear (in the direction of arrow W), yielding to the pressing force thereof, as shown in FIG. 3. As a result, a chain G does not get caught on the side of the large diameter gear, and so the main guard 7 can be moved toward the large diameter gear side by a desired amount, and the chain is pressed by the lower end portion 7a (see FIG. 1) of the main guard near the tip of the teeth of the large diameter gear, thus ensuring and enabling shifting to proceed smoothly.

In contrast, in the conventional transmission for a bicycle, an integrated non-elastic guard N is formed, and because it is not distinguished either as the main guard or auxiliary guard, when it is re-installed from the middle diameter gear to the large diameter gear, the chain is caught on the flank of the small diameter gear side of the large diameter gear, thus preventing such movement as would ensure and allow shifting of the gears by a certain distance marked L in FIG. 4, to proceed smoothly. In this connection, while it is preferable for the auxiliary guard to be installed on the main guard at the rear from the center of the seat pipe in the longitudinal direction of the bicycle, it is also preferable that the chain be installed by a pin or the like in a position in which the lower end portion 8b of the auxiliary pressing the chain would not be easily displaced or deformed when the small diameter gear is shifted to the middle diameter gear.

Where the chain is re-installed from the large diameter gear to the small diameter gear, the chain is pressed to the side of the small diameter gear side by a step press portion 7b (see FIG. 1) of the main guard using the return force of the return spring 17 by returning the shift lever S. Since the shape of this portion is similar to that of the conventional article, the shifting performance obtained is identical to that of the latter.

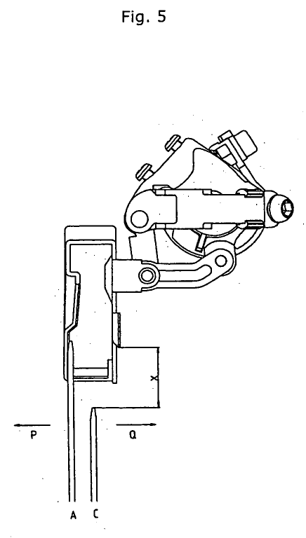

Next, as shown in FIG. 5, when the transmission is combined with the front chain wheel provided with two sheets of gear plates, normally, when a gap X between the tip of the teeth of the small diameter gear and the internal guard is large and the large diameter gear shifts to the small diameter gear, the chain sometimes falls off inwardly in the lateral direction of the bicycle from the gap X. However, when the present invention is utilized, such gaps can be made smaller, thus preventing the chain from falling off, at the same time ensuring that shifting from the small diameter gear to the large diameter gear is equal to that of the conventional article.

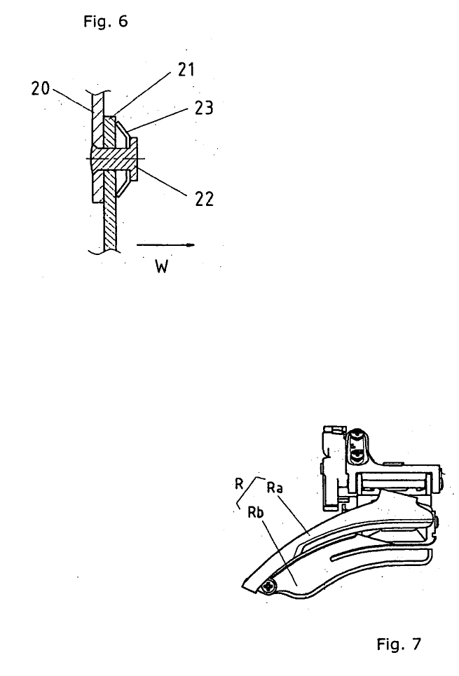

The present invention is not limited to the above-described embodiments, but as reflected in the second embodiment shown in FIG. 6, the main guard 20 and the auxiliary guard 21 are made of rigid material, and the auxiliary guard may be installed in the main guard so as to be displaced at least inwardly in the lateral direction of the bicycle (in the direction of arrow W) through the plate spring 23 by the pin 22, and as reflected in the third embodiment shown in FIG. 7, where the main guard portion and the auxiliary guard portion are provided, the guard R is formed of an elastic body, constituting the main guard portion Ra and the auxiliary guard portion Rb, where the auxiliary guard portion is shaped in such manner as to be elastically displaceable by external force.

### INDUSTRIAL APPLICABILITY

As described above, the transmission of the present invention considerably addresses the problems associated with the front wheel of the conventional transmission for a bicycle by remarkably enhancing shifting performance. In the case of the conventional transmission combined with the front chain wheel provided with three gears, attempts to improve shifting performance from the small diameter gear to the middle diameter gear has resulted in lower shifting performance from the middle diameter gear to the large diameter gear, and conversely, while attempts to improve shifting performance from the middle diameter gear to the large diameter gear has also led to a decrease in shifting performance from the small diameter gear to the middle diameter gear.

In the present invention, the guards of the transmission for the bicycle comprise two sheets, i.e., the main guard and the auxiliary guard, and the auxiliary guard is installed in the main guard so as to be elastically displaceable at a radially lower position vis-à-vis the main guard with respect to the shaft axis of the front chain wheel, such that when the small diameter gear shifts to the middle diameter gear, the auxiliary guard presses the chain to allow shifting, and therefore shifting performance equal to that of the conventional article is attained, and when the middle diameter gear shifts to the large diameter gear such that the chain is consequently pressed to the side of the large diameter gear, the auxiliary guard is displaced so as to escape onto the side opposite the large diameter gear. As a result, the chain shifts to the large diameter smoothly without tucking the chain between the guard and the large diameter gear.

Further, where the conventional transmission is used together with the front chain wheel provided with two sheets of gear plates, when the large diameter gear shifts to the small diameter gear, the chain sometimes jumps over the small diameter gear and falls off since the internal guard does not greatly extend to the shaft axial direction of the front chain wheel. On the contrary, in the transmission for a bicycle of the present invention, the guard can be largely extended in the shaft axial direction of the front chain wheel because it is positioned radially downward, thereby preventing the chain from falling off.

1. A transmission for a bicycle for re-installing the chain in the front chain wheel provided with two or more sheets of gear plates in the lateral direction of the bicycle and comprising two guards, i.e., a main guard for shifting from a middle diameter gear to a large diameter gear, and an auxiliary guard for shifting from a small diameter gear to a middle diameter gear, wherein the main guard is pivotally supported by a link mechanism for moving the guard in the lateral direction of the bicycle, and the auxiliary guard is installed in the main guard so as to be elastically displaceable at a position in which the rear end side from the center of a seat pipe, that is, the lower end portion of the auxiliary guard pressing the chain when the small diameter gear is shifted to the middle diameter gear, cannot be easily displaced or deformed.

2. The transmission for a bicycle according to claim 1, wherein the main guard and the auxiliary guard are respectively positioned radially up and down with respect to the shaft axis of the front chain wheel.

3. (canceled)

4. The transmission for a bicycle according to claim 1, wherein the auxiliary guard is installed in the main guard by a pin or welding means.

5. The transmission for a bicycle according to claim 4, wherein the auxiliary guard is formed from a displaceable elastic body.

6. The transmission for a bicycle according to claim 1, wherein the auxiliary guard is a rigid body installed on the main guard by a pin or the like through the elastic body.

7. (canceled)
